(19) United States
(12) Patent Application Publication
(10) Pub. No.: US 2009/0227323 A1
(43) Pub. Date: Sep. 10, 2009

(54) Slot Machine

(75) Inventor: Hiroki SAITO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/115,112

(22) Filed: May 5, 2008

Related U.S. Application Data
(60) Provisional application No. 61/033,919, filed on Mar. 5, 2008.

(51) Int. Cl. A63F 13/00

(52) U.S. Cl. 463/20

(57) ABSTRACT

A slot machine of the present invention includes a symbol matrix display area, first reels, second reels that are provided in an outer peripheral side of the first reels so as to enclose a plurality of the first reels, and a processor. The processor is configured to (a) rearrange first symbols arranged on the first reels in the symbol matrix display area, (b) rearrange the second symbols arranged on the second reels in the symbol matrix display area in a manner superposing the second symbols arranged on the second reels on the first symbols of the first reels rearranged in the symbol matrix display area, and (c) provide a prize after changing a payout with respect to a winning combination by the first symbols based on the second symbols of the second reels rearranged after superposed on the first symbols, in case that a combination of the first symbols of the first reels arranged in the symbol matrix display area is a winning combination on an activated line in a column direction, in the row direction, or in a diagonal direction.

### CROSS-REFERENCE TO RELATED APPLICATIONS

This application claims priority of U.S. Provisional Application No. 61/033,919 filed on Mar. 5, 2008. The contents of this application are incorporated herein by reference in their entirety.

### BACKGROUND OF THE INVENTION

1. Field of the Invention

The present invention relates to a slot machine.

2. Description of the Related Art

In a conventional slot machine, when a player inserts a game medium, such as a coin and a bill, in an insertion slot of a slot machine and presses a SPIN button, a display provided on a front face of a cabinet displays a plurality of symbols in a scrolling manner. Then, scrolling of each of the symbols automatically stops.

As such a slot machine, for example, as disclosed in U.S. Pat. No. 6,093,102, a slot machine exists which employs a concept of a winning line. In this concept, in case that a combination of symbols rearranged on a winning line is a predetermined winning combination, a predetermined number of game media are paid out.

In addition, as such a slot machine, for example, as disclosed in each of U.S. Pat. No. 6,604,999 and U.S. Patent Publication No. 2002/0065124, a slot machine exists which provides two types of payouts, including a payout determined by a combination of symbols rearranged on a winning line and a payout determined by a number of displayed scatter symbols.

In the above-described conventional slot machine, a position of a winning line on which a winning combination is established or a displaying position of a scatter symbol is not related to a payout. Accordingly, a prolonged need exists for the advent of a slot machine which is capable of offering new entertainability.

The present invention has been made in view of the above-described circumstance. An object of the present invention is to provide a novel slot machine by enhancing entertainability in rearrangement of symbols.

### SUMMARY OF THE INVENTION

A first aspect of the present invention is a slot machine, including: a symbol matrix display area in which a plurality of symbols are arranged in a column direction and in a row direction; a plurality of first reels that are provided corresponding to individual areas of the symbol matrix display area, and that have a plurality of kinds of first symbols different in payouts arranged thereon; second reels that are provided on an outer peripheral side of the plurality of first reels so as to enclose first reels provided in the column direction among the plurality of first reels; and a processor that controls drive of the first reels and the second reels, wherein: the second reels have second symbols arranged thereon, the second symbols being rearranged after superposed on the first symbols of the first reels when the first symbols are rearranged in the symbol matrix display area, the second symbols changing a payout of the first symbols of the first reels to a higher payout or a lower payout, and the processor is programmed to: (a) control rotation of the plurality of the first reels to rearrange the first symbols arranged on the first reels in the symbol matrix display area; (b) control rotation of the second reels to rearrange the second symbols arranged on the second reels in the symbol matrix display area so as to superpose the second symbols arranged on the second reels on the first symbols of the first reels rearranged in the symbol matrix display area; and (c) award a prize after changing a payout with respect to a winning combination by the first symbols based on the second symbols of the second reels rearranged after superposed on the first symbols, in case that rearrangement of the first symbols of the first reels rearranged in the symbol matrix display area is a winning combination on an activated line in the column direction, the row direction, or a diagonal direction.

According to the first aspect of the present invention, a level up symbol is rearranged after superposed on a rearranged symbol. Therefore, for example, when a symbol “1Bar” is rearranged and a level up symbol “+2” is rearranged after superposed on the symbol, a prize is provided after a payout is changed to “3Bar”. Accordingly, the player raises expectations for a prize by the second symbol, and the entertainability in rearrangement of symbols can be enhanced.

A second aspect of the present invention is a slot machine in which the second reels are provided corresponding to one of the plurality of the plurality of first reels arranged in the row direction.

According to the second aspect of the present invention, a level up symbol is rearranged after superposed on a rearranged symbol. Therefore, for example, in case that a winning combination of symbols “1Bar-1Bar-1Bar” is rearranged and a second symbol “+2” is rearranged after superposed on any one of the symbols in winning combination, a prize is awarded after a payout is changed to that of a winning combination of symbols “3Bar-3Bar-3Bar”. Accordingly, the player raises expectations for a prize by the second symbol, and the entertainability in rearrangement of symbols can be enhanced.

A third aspect of the present invention is a slot machine in which the processor awards a prize after changing a payout with respect to a winning combination by the first symbols based on the second symbols of the second reels rearranged after superposed on the first symbols, in case that the same second symbols of the second reels are rearranged after superposed on all of the first symbols of the first reels constituting the winning combination in the process (c).

According to the third aspect of the present invention, the second symbol is rearranged after superposed on a rearranged symbol. Therefore, for example, in case that a winning combination of symbols “1Bar-1Bar-1Bar” is rearranged and the second symbols “+2-+2-+2” are rearranged after superposed on the winning combination of the symbols, a prize is awarded after a payout is changed to that of a winning combination of symbols “3Bar-3Bar-3Bar”. Accordingly, the player raises expectations for a prize by the second symbol, and the entertainability in rearrangement of symbols can be enhanced.

A fourth aspect of the present invention is a slot machine constituted as set forth in below, including: a symbol matrix display area in which a plurality of symbols are arranged in a column direction and in a row direction; a plurality of first reels that are provided corresponding to individual areas of the symbol matrix display area, and that have a plurality of kinds of first symbols different in payouts arranged thereon; second reels that are provided on an outer peripheral side of the plurality of first reels so as to enclose first reels provided in the column direction among the plurality of first reels; and a processor that controls drive of the first reels and the second reels, wherein: the second reels are provided corresponding to one of the plurality of first reels arranged in the row direction, and have second symbols arranged thereon, the second symbols being arranged after superposed on the first symbols of the first reels when the first symbols are rearranged in the symbol matrix display area, the second symbols changing a payout of the first symbols of the first reels to a higher payout or a lower payout, and the processor is programmed to: (a) control rotation of the plurality of first reels to rearrange the first symbols arranged on the first reels in the symbol matrix display area; (b) control rotation of the second reels to rearrange the second symbols arranged on the second reels in the symbol matrix display area so as to superpose the second symbols arranged on the second reels on the first symbols of the first reels rearranged in the symbol matrix display area; and (c) award a prize after changing a payout with respect to a winning combination by the first symbols based on the second symbols of the second reels rearranged after superposed on the first symbols, in case that rearrangement of the first symbols of the first reels rearranged in the symbol matrix display area is a winning combination on an activated line in the column direction, the row direction, or a diagonal direction.

According to the fourth aspect of the present invention, a second symbol is rearranged after superposed on a rearranged symbol. Therefore, for example, in case a symbol “2Bar” is rearranged and a second symbol “+2” is rearranged after superposed thereon, a prize is awarded after a payout is changed to that of a combination of symbols “7”. In addition, in case that a winning combination of symbols “3Bar-3Bar-3Bar” is rearranged, and the second symbol “+2” is rearranged after superposed on any one of the symbols in the winning combination, a prize is awarded after a payout is changed to that of symbols “WILD-WILD-WILD”. Accordingly, the player raises expectations for a prize by the second symbol, and the entertainability in rearrangement of symbols can be enhanced.

A fifth aspect of the present invention is a slot machine in which the processor awards a prize after changing a payout with respect to a winning combination by first symbols based on second symbols of second reels rearranged after superposed on the first symbols, in case that the same second symbols of the second reels are rearranged after superposed on all of the first symbols of the first reels constituting the winning combination in the process (c).

According to the fifth aspect of the present invention, a second symbol is rearranged after superposed on a rearranged symbol. Therefore, for example, in case that a symbol “2Bar” is rearranged and a second symbol “+3” is rearranged after superposed on the symbol, a prize is awarded after a payout is changed to that of a combination of symbols “WILD”. In addition, in case that a winning combination of symbols “3Bar-3Bar-3Bar” are rearranged, and second symbols “+1-+1-+1” are rearranged after superposed thereon, a prize is awarded after a payout is changed to that of symbols “7-7-7”. Accordingly, the player raises expectations for a prize by the second symbol, and the entertainability in rearrangement of symbols can be enhanced.

A sixth aspect of the present invention is a slot machine, including: a symbol matrix display area in which a plurality of symbols are arranged in a column direction and in a row direction; a plurality of first reels that are provided corresponding to individual areas of the symbol matrix display area, and that have a plurality of kinds of first symbols different in payouts arranged thereon; second reels that are provided on an outer peripheral side of the plurality of first reels so as to enclose first reels provided in the column direction among the plurality of first reels; and a processor that controls drive of the first reels and the second reels, wherein: the second reels have second symbols arranged thereon, the second symbols being arranged after superposed on first symbols of the first reels when the first symbols are arranged in the symbol matrix display area, the second symbols changing a payout of the first symbols of the first reels to a higher payout or a lower payout, and the processor is programmed to: (a) control rotation of the plurality of first reels to rearrange the first symbols arranged on the first reels in the symbol matrix display area; (b) control rotation of the second reels to rearrange the second symbols arranged on the second reels in the symbol matrix display area so as to superpose the second symbols arranged on the second reels on the first symbols of the first reels rearranged in the symbol matrix display area; and (c) award a prize after changing a payout with respect to a winning combination by the first symbols based on the second symbols of the second reels rearranged after superposed on the first symbols, in case that rearrangement of the first symbols of the first reels rearranged in the symbol matrix display area is a winning combination on an activated line in the column direction, in the row direction, or in a diagonal direction, and the same second symbols of the second reels are rearranged after superposed on all of the first symbols of the first reels that constitute the winning combination.

According to the sixth aspect of the present invention, a second symbol is rearranged after superposed on a rearranged symbol. Therefore, for example, in case that a symbol “Blank” is rearranged and a second symbol “+4” is rearranged after superposed on the symbol, a prize is awarded after a payout is changed to that of a winning combination of symbols “WILD”. In addition, in case that a winning combination of symbols “3Bar-3Bar-3Bar” is rearranged, and second symbols “+2-+2-+2” are rearranged after superposed on the symbols, a prize is awarded after a payout is changed to that of a winning combination of symbols “WILD-WILD-WILD”. Accordingly, the player raises expectations for a prize by the second symbol, and the entertainability in rearrangement of symbols can be improved.

### BRIEF DESCRIPTION OF THE DRAWINGS

FIG. 1 is a view showing an outline of symbol rearrangement according to a first embodiment;

FIG. 2 is a perspective view schematically showing a slot machine according to the first embodiment;

FIG. 3 is a perspective view schematically showing a reel according to the first embodiment;

FIG. 4 is a view showing an internal construction of the slot machine shown in FIG. 2;

FIG. 5 is a view showing an internal construction of the reel shown in FIG. 4;

FIG. 6 is a view showing a correspondence relationship between various symbols and payouts at the time of a basic game according to the first embodiment;

FIG. 7A is a view showing one example of an image displayed in the slot machine shown in FIG. 2 according to the first embodiment;

FIG. 7B is a view showing one example of an image displayed in the slot machine shown in FIG. 2 according to the first embodiment;

FIG. 8 is a flowchart showing a subroutine of main process according to the first embodiment;

FIG. 9 is a flowchart showing a subroutine of gaming execution process according to the first embodiment;

FIG. 10 is a flowchart showing a subroutine of symbol rearrangement process according to the first embodiment;

FIG. 11 is a view showing one example of the symbol rearrangement according to a second embodiment;

FIG. 12 is a flowchart showing a subroutine of the symbol rearrangement process according to the second embodiment;

FIG. 13 is a view showing one example of the symbol rearrangement according to a third embodiment; and

FIG. 14 is a flowchart showing a subroutine of the symbol rearrangement process according to the second embodiment.

### DESCRIPTION OF THE PREFERRED EMBODIMENTS

First, a slot machine 10 according to a first embodiment will be described in detail with reference to the drawings. Here, the slot machine according to the first embodiment described below is a so-called hybrid type slot machine, which has a transparent liquid crystal panel allocated in front of a plurality of mechanical reels supported in a rotatable manner, and executes a game by displaying images of various symbols drawn on an external peripheral surface of the mechanical reels through the transparent liquid crystal panel.

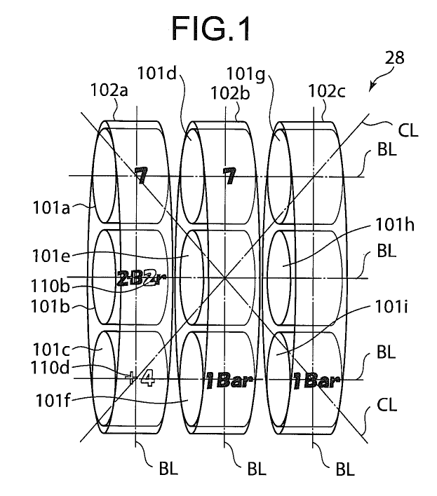

FIG. 1 is a view showing one example of rearranged symbols according to the first embodiment. As shown in FIG. 1, a total of nine reels 101a to 101i in three rows and three columns are provided in a rotatable manner in a symbol display area 28. In addition, the reels 101a to 101i are in a double structure with level up reels 102a to 102c rotating externally. The level up reels 102a to 102c are provided so as to enclose three of the reels 101 provided in a column direction. In the symbol display area 28, six basic lines BL are set along the column direction or a row direction. In the embodiments of the present invention, each of the basic lines is defined as a winning line other than a cross line. Furthermore, two cross lines CL obliquely across the symbol display area 28 are set. The eight winning lines in the embodiments of the present invention include the basic lines BL and the cross lines CL.

In the embodiments of the present invention, in the symbol display area 28, any of symbols “Blank”, “1Bar”, “2Bar, “3Bar”, “7”, and “WILD” is rearranged by the reels 101a to 101i (a first reel), and any of symbols “Blank”, “+1”, “+2”, “+3”, and “+4” is rearranged by the level up reels 102a to 102c provided in the column direction at the outside of the reels 101a to 101i. A payout is changed and determined based on level up symbols 110 rearranged after superposed on the above symbols. Here, symbols “7” are rearranged on the reels 101a and 101d, a symbol “2Bar” is rearranged on the reel 101b, symbols “7” are rearranged on the reels 101d and 101f, and symbols “Blank” are rearranged on the other reels. In this case, no winning-line combination is established, and the player cannot obtain a payout. However, when on the level up reel 102a the level up symbol 110d of “+2” is rearranged after superposed on the reel 101b, and further, the level up symbol 110d of “+4” is rearranged on the reel 101c, a level of the symbol “2Bar” rearranged on the reel 101b is increased to that of a symbol “7”, and a level of the symbol “Blank” rearranged on the reel 101c is increased to that of a symbol “7”, and a payout is changed to that which is performed when a combination of symbols “7-7-7” is rearranged on the basic line BL.

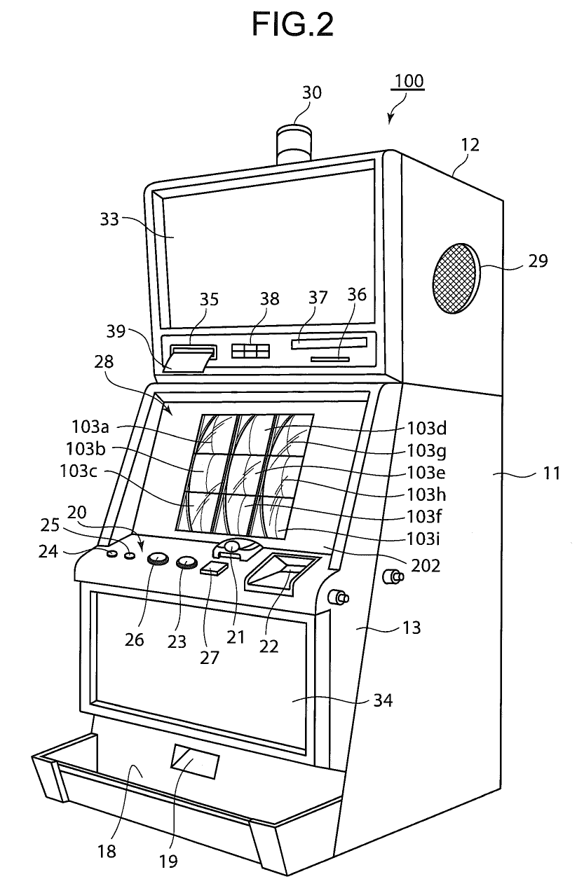

FIG. 2 is a view schematically depicting a frame format of an appearance of the slot machine according to the first embodiment. The gaming media used in the slot machine 10 include coins, bills, or electronic value information equivalent thereto. In the present invention, however, the gaming media are not limitative thereto in particular, and can include medals, tokens, electric money, and tickets, for example. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11.

A lower image display panel 16 serving as a display is provided in front of the main door 13. The lower image display panel 16 is provided with a liquid crystal panel to display various types of information or images such as effect images during the play of the game.

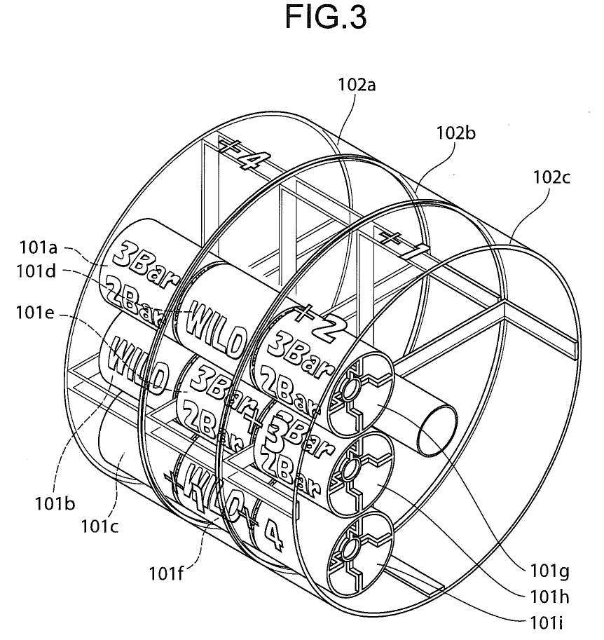

A symbol display area 28 for displaying symbols is provided at the center of the lower image display panel 16. In the symbol display area 28, nine display windows 103a to 103i are formed which allow a rear side thereof to be visually recognized, and, as shown in FIG. 3, nine reels 101a to 101i are rotatably provided. In addition, the reels 101a to 101i are in a double structure with level up reels 102a to 102c that rotate outside of them. The level up reels 102a to 102c are provided so as to enclose three of the reels 101 provided in a column direction. The outside level up reels 102a to 102c and the inside rotational reels 101a to 101i have independent rotational axes, respectively. The rotational axes of the level up reels 102a to 102c are positioned at a rear side of the reels 101a to 101i when viewed from the symbol display area 28. These axes are rotationally driven by means of separate motors. A symbol column made up of the symbols “Blank”, “1Bar”, “2Bar”, “3Bar”, “7”, and “WILD” is drawn on the outer circumferential surface of each of the reels 101a to 101i. On the other hand, a half perimeter of the level up reels 102a to 102c is transparent so that each of the reels 101a to 101i can be visually recognized. The remaining half perimeter of the level up reels 102a to 102c has a level up symbol column made up of the symbols “+1”, “+2”, “+3”, and “+4” drawn thereon, in a manner such that symbols on the reels 101a to 101i can be visually recognized.

Six basic lines BL are set along the column direction or the row direction of the symbol display area 28, and two cross lines CL obliquely across the symbol display area 28 are set in the lower image display panel 16. The basic lines BL and the cross lines CL serving as the winning lines specify combinations of symbols.

A payout amount display unit 31 of the lower image display panel 16 displays the number of coins credited by way of an image. A payout amount display unit 32 displays by way of an image the number of coins to be paid if a predetermined combination of symbols are rearranged on the winning line.

Provided on a lower side of the lower image display panel 16 are a control panel 20 having a plurality of buttons 23 to 27 through which command regarding the process of the game will be input by a player, a coin receiving slot 21 for receiving coins into the cabinet 11, and a bill validator 22.

On the control panel 20, a start button 23, a change button 24, a cashout button 25, a 1-BET button 26, and a max-BET button 27 are provided. The start button 23 is intended for entering a command for starting the game. The change button 24 is intended for use in asking an attendant of the gaming facility for change. The cashout button 25 is intended for entering a command for paying the credited coins to a coin tray 18 through a coin payout exit 19.

The 1-BET button 26 is intended for entering a command for betting one coin among the credited coins on the game. The max-BET button 27 is intended for entering a command for betting the upper number (50 in this embodiment) of coins that can be bet per game among the credited coins on the game.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On a front surface of the top box 12, an upper image display panel 33 is provided. The upper image display panel 33 has a liquid crystal panel, which displays images for introducing the game contents or explaining game rules, for example.

Also, on the top box 12, a lamp 30 and a speaker 29 are provided. On a lower side of the upper image display panel 33, a ticket printer 35, a card reader 36, a data display 37, and a key pad 38 are provided. The ticket printer 35 prints on the ticket, a barcode having encoded thereon data such as the credit amount, the date and time, and the identification number of the slot machine 10, and outputs the printed ticket as the barcode-attached ticket 39. The player can play the game on another slot machine with the barcode attached ticket 39 by causing this slot machine to read the barcode attached ticket 39. Alternatively, the player can exchange the barcode-attached ticket 39 with the bills or the like at a predetermined place (at a cashier inside a casino, for example) of the gaming facility.

The card reader 36 reads data from and write data into a smart card. The smart card is to be owned by the player, which stores data for identifying the player or data regarding the log of games executed by the player, for example. The smart chard may store data corresponding to coins, bills, or a credit. As an alternative of a smart card, a magnetic stripe card may be employed. The data display 37 is made up of a fluorescent display and the like, and displays the data read by the card reader or the data input by the player through the key pad 38, for example. The key pad 38 inputs data and commands regarding the ticket issuance or the like.

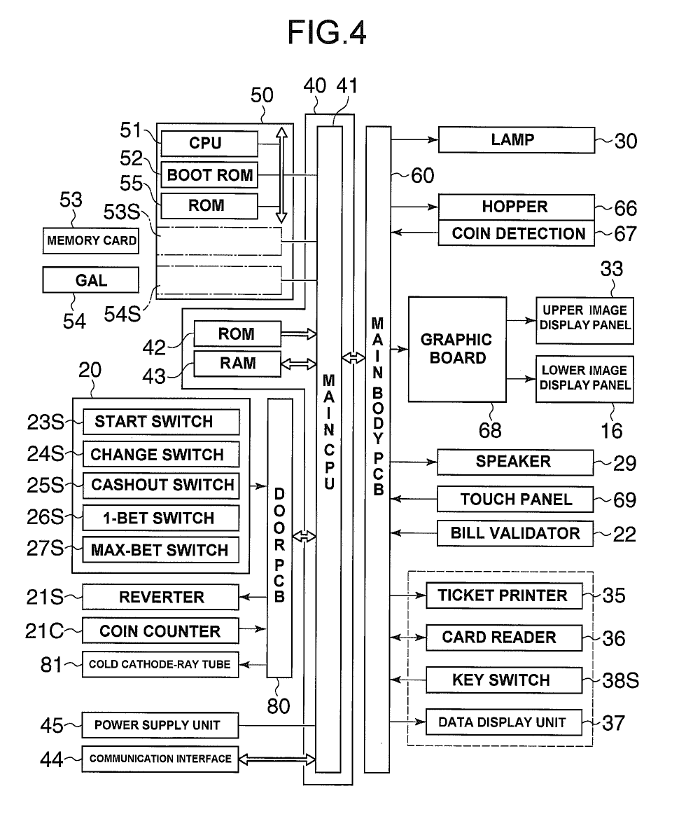

FIG. 4 is a block diagram depicting the internal construction of the slot machine shown in FIG. 2. A gaming board 50 includes: a CPU (Central Processing Unit) 51, a ROM (Read Only Memory) 55 and a boot ROM 52 interconnected by an internal bus; a card slot 53S corresponding to a memory card 53; and an IC socket 54S corresponding to a GAL (Generic Array Logic) 54.

A memory card 53 is composed of a non-volatile memory, such as CompactFlash (registered trademark), and stores a game program. The game program includes a symbol selection program. The symbol selection program is intended for determining symbols to be rearranged on a symbol matrix SM. The symbol selection program includes symbol weighing data corresponding to each of a plurality of kinds of payout ratios (for example, 80%, 84%, and 88%). The symbol weighing data is indicative of the correspondence relationship between a code number of each symbol and a level up symbol, and one or more random number values which come under a predetermined numerical range (0 to 256), with respect to each of the reels 101a to 101i and the level up reels 102a to 102c. The payout ratio is determined according to the payout-ratio setting data output from the GAL 54. The symbols to be stopped and displayed are determined depending upon the symbol weighing data corresponding to this payout ratio.

Also, the card slot 53S is configured to allow the memory card 53 to be inserted thereinto or ejected therefrom, and is connected to a mother board 40. Accordingly, the memory card 53 can be ejected from the card slot 53S, other game programs and other game system programs can then be written into the memory card 53, and further, the memory card 53 can be inserted into the card slot 53S, thereby allowing the player to change the types and contents of games executed in the slot machine 10.

The GAL 54 is a type of a PLD having a fixed OR array structure. The GAL 54 includes plural input ports and plural output ports. Where predetermined data is input to the input port, the GAL 54 outputs data corresponding to the aforementioned data from the output port. The data output from this output port is equivalent to the aforementioned payout-ratio setting data. Further, the IC socket 54S is configured to allow the GAL 54 to be attached thereto and detached therefrom, and is connected to the mother board 40 by a PCI bus. Accordingly, the GAL can be replaced with the replacement GAL 54 to change the payout-ratio setting data.

The CPU 51, the ROM 55, and the boot ROM 52 interconnected by the internal bus are connected to the mother board 40 by the PCI bus. The PCI bus serves to transmit signals between the mother board 40 and the gaming board 50 and supply power from the mother board 40 to the gaming board 50.

The mother board 40 is constructed using a general-purpose mother board commercially available (a printed circuit board on which essential parts of a personal computer are mounted) and includes: a main CPU 41, a ROM (Read Only Memory) 42; a RAM (Random Access Memory) 43; and a communication interface 44. The main CPU 41 functions as a processor for controlling a display device and memory according to the embodiment of the present invention.

The ROM 42 is made up of a memory device such as a flash memory and stores thereon a program such as BIOS (Basic Input/Output System) executed by the main CPU 41, and permanent data. When the BIOS is executed by the main CPU 41, processing of initializing predetermined peripheral devices is carried out and processing of capturing game programs and game system programs stored in the memory card 53 through the gaming board 50 is started. In the present invention, the contents of the ROM 42 may be rewritable or not.

The RAM 43 stores data and a program used when the main CPU 41 is activated. The RAM 43 can also store game programs. The RAM 43 further stores data concerning the credit amount, the number of coin-in or coin-out for one game, and the like.

Both a main body PCB (Printed Circuit Board) 60 and a door PCB 80, which will be described later, are connected to the mother board 40 by USB. A power supply unit 45 is also connected to the mother board 40.

Connected to the main body PCB 60 and the door PCB 80 are: equipment and devices which generate input signals to be input to the main CPU 41; and equipment and devices of which operations are controlled by a control signal output from the main CPU 41. The main CPU 41 executes a game program stored in the RAM 43 based on an input signal having been input to the main CPU 41 and performs a predetermined computational process, thereby storing results thereof in the RAM 43 or transmitting a control signal to each of equipment and devices as a control process therefor.

Connected to the main body PCB 60 are a lamp 30, a reel control section 72, a hopper 66, a coin detecting section 67, a graphic board 68, a speaker 29, a touch panel 69, a bill validator 22, a ticket printer 35, a card reader 36, a key switch 38S, and a data display 37. The lamp 30 illuminates in a predetermined pattern, based on a control signal output from a main CPU 41.

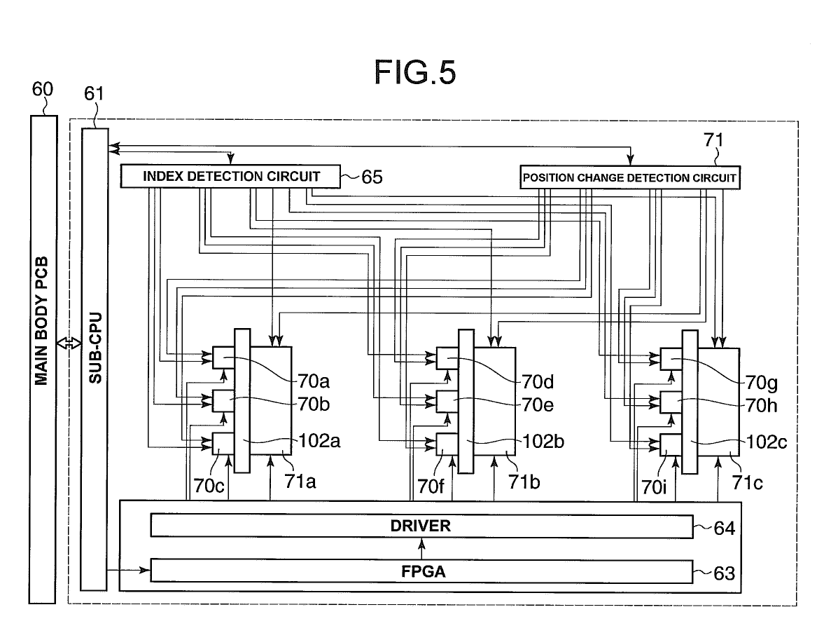

As shown in FIG. 5, a sub CPU 61 included in the reel control section 72 controls rotation and stop of the reels 101a to 101i and the level up reels 102a to 102c. A motor driving circuit 62 including an FPGA (Field Programmable Gate Array) 63 and a driver 64 are connected to the sub CPU 61. The FPGA 63 is an electronic circuit, such as a programmable LSI, and functions as a control circuit of stepping motors 70 and 90. The driver 64 functions as an amplifier circuit of a pulse input to the stepping motors 70 and 90. The motor driving circuit 62 is connected to stepping motors 70a to 70i that rotate the reels 101a to 101i, respectively, and stepping motors 90a to 90c that rotate the level up symbols 102a to 102c, respectively. The stepping motors 70 and 90 are stepping motors of one-two phase excitation mode.

In addition, an index detection circuit 65 and a position change detection circuit 71 are connected to the sub CPU 61. The index detection circuit 65 detects positions (indices described later) of the level up symbols 102a to 102c and the reels 101a to 101i being rotated. Further, the index detection circuit 65 can detect loss of synchronization between the reels 101a to 101i and the level up symbols 102a to 102c.

The position change detection circuit 71 detects change of stopping positions of the reels 101a to 101i and the level up symbols 102a to 102c after rotation of the reels 101a to 101i and the level up symbols 102a to 102c is stopped. For example, the position change detection circuit 71 detects change of stopping positions of the reels 101a to 101i and the level up symbols 102a to 102c with respect to a case in which the player forcibly changes the stopping positions which are not in a winning combination to a winning combination. The position change detection circuit 71, for example, detects fins (not shown) mounted at predetermined intervals to an inner part of the reels 101a to 101i and the level up symbols 102a to 102c to be able to detect change of stopping positions of the reels 101a to 101i and the level up symbols 102a to 102c.

The hopper 66 is installed in the cabinet 11 and pays out a predetermined number of coins from the coin payout exit 19 to the coin tray 18 based on a control signal output from the main CPU 41. The coin detecting section 67 is installed inside the coin payout exit 19 and outputs an input signal to the main CPU 41 upon detecting that a predetermined number of coins have been paid out from the coin payout exit 19.

The graphic board 68 controls, based on a control signal output from the main CPU 41, images to be displayed on the upper image display panel 33 and the lower image display panel 16. The credit amount stored in the RAM 43 is displayed on a credit amount display section 31 (see FIG. 2) of the lower image display panel 16. The number of coins to be paid out is displayed at a payout amount display section 31 (see FIG. 2) of the lower image display panel 16. The graphic board 68 is equipped with a DVP (Video Display Processor) which generates image data based on a control signal output from the main CPU 41 and a video RAM which temporarily stores image data generated by the VDP, and the like. The image data used in generating image data with VDP is contained in the game program read from the memory card 53 and stored in the RAM 43.

The bill validator 22 validates whether or not a bill is legitimate and accepts a legitimate bill into the cabinet 11. Upon accepting a legitimate bill, the bill validator 22 outputs an input signal to the main CPU 41 based on the amount of the bill. The main CPU 41 stores in the RAM 43 the credit amount corresponding to the amount of bills transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as a barcode-attached ticket 39. The card reader 36 transmits to the main CPU 41 the data read from the smart card and writes the read data onto the smart card, based on a control signal from the main CPU 41. The key pad switch 38S is provided on the key pad 38, and outputs a predetermined input signal to the main CPU 41 when the player operates the key pad 38. The data display 37, based on a control signal output from the main CPU 41, displays the data read by the card reader 36 and the data input by the player through the key pad 38.

A control panel 20, a reverter 21S, a coin counter 21C, and a cold cathode tube 81 are connected to a door PCB 80. The control panel 20 is provided with: a start switch 23S corresponding to the start button 23; a change switch 24S corresponding to the change button 24; a cashout switch 25S corresponding to a cashout button 25; a 1-BET switch 26S corresponding to a 1-BET button 26; and a max-BET switch 27S corresponding to the max BET button 27. When the player operates the buttons 23 to 27, the corresponding switches 23S to 27S output input-signals to the main CPU 41, respectively.

The coin counter 21C is provided inside the coin receiving slot 21, and validates whether or not a legitimate coin is inserted into the coin receiving slot 21. Those other than the legitimate coins are discharged from the coin payout exit 19. The coin counter 21C outputs an input signal to the main CPU 41 when a legitimate coin is detected.

The reverter 21S operates based on a control signal output from the main CPU 41 and distributes coins recognized as being legitimate by the coin counter 21C into a cash box (not shown in the drawings) or the hopper 66 which is arranged in the slot machine 10. In other words, when the hopper 66 is filled with coins, legitimate coins are distributed by the reverter 21S into the cash box. On the other hand, when the hopper 66 is not filled with coins, legitimate coins are distributed into the hopper 66. A cold cathode tube 81 functions as a backlight installed on rear face side of each of the lower image display panel 16 and the upper image display panel 33, and is lit up based on a control signal output from the main CPU 41.

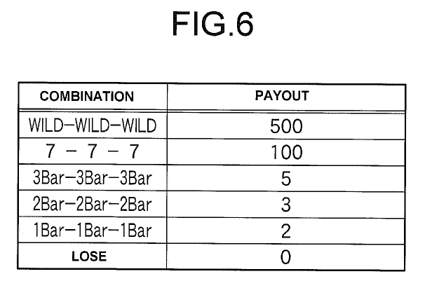

FIG. 6 is a view showing a correspondence relationship between various symbols and payouts at the time of a basic game according to the first embodiment. As shown in FIG. 6, when predetermined symbols are rearranged on a winning line on which the player has bet, a payout is determined based on a winning combination. Here, the player can obtain a corresponding payout in accordance with any of the winning combinations of symbols “WILD-WILD-WILD”, “7-7-7”, “3Bar-3Bar-3Bar”, “2Bar-2Bar-2Bar”, and “1Bar-1Bar-1Bar” on the basic lines BL and the cross lines CL which are winning lines set in the symbol display area 28. In addition, in case that a combination of symbols “WILD-WILD-WILD” is rearranged on a winning line, the player obtains a payout of “500”, and can move into a bonus game. Here, the bonus game is executed after the basic game is played, and is generally advantageous to the player.

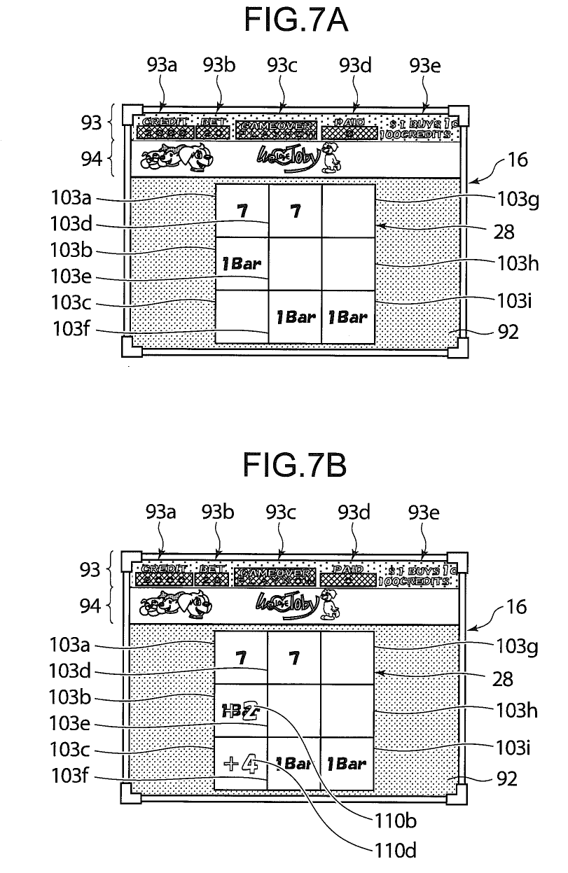

FIGS. 7A and 7B are views each showing one example of an image displayed in the slot machine shown in FIG. 2 according to the first embodiment. FIG. 7A is a view showing one example of symbol rearrangement according to the first embodiment. FIG. 7B is a view showing one example of level up symbol rearrangement according to the first embodiment. As shown in FIG. 7A, the lower image display panel 16 is made up of display-related sections such as a display area section 92, an information display section 93, and an effect image display section 94. The display area section 92 is for displaying a symbol matrix SM. In addition, the information display section 93 is arranged above the display area section 92. This display section is made up of a credit amount display section 93a, a BET amount display section 93b, a character information display portion 93c, a PAID amount display section 93d, and a charge display section 93e.

The number of coins presently credited is displayed at the credit amount display section 93a while the number of coins bet in one game is displayed at the BET amount display section 93b. The character information indicative of a current status of the game is displayed at the character information display section 93. The characters of “PLAYNOW” are displayed during the play of the game, whereas the characters of “GAMEOVER” are displayed at the intervals between the plays of the game. The number of coins that has been successfully obtained in one game is displayed at the PAID amount display section 93d, whereas a conversion value of the credit amount based on a predetermined charge is displayed at the charge display section.

At the effect image display section 94, effect images in accordance with a type of the present slot game are displayed. Therefore, the effect image display section 94 displays effects images which are different depending on the basic and free games.

In the symbol display area 28 of the lower image display panel 16, when the reels 101a to 101i stop, a total of nine symbols in three rows and three columns are rearranged. In the symbol display area 28, any of the symbols “Blank”, “1Bar”, “2Bar”, “3Bar”, “7”, and “WILD” is rearranged. When the reels 101a to 101i are stopped, the symbols “1Bar” are rearranged on the display windows 103b, 103f, and 103i, and the symbols “7” are rearranged on the display windows 103a and 103d.

As shown in FIG. 7B, after any of the symbols “Blank”, “1Bar”, “2Bar”, “3Bar”, “7”, and “WILD” is rearranged in the symbol display area 28 of the lower image display panel 16, the level up reel 102a to 102c are stopped, and then, the corresponding level up symbols are rearranged. In this example, in FIG. 7A, when the level up symbol 110b of “+2” and the level up symbol 110d of “+4” are rearranged in the display windows 103b and 103c after superposed on the reel 101, the levels of the symbols “2Bar” rearranged in the display window 103b and the symbols “Blank” rearranged in the display window 103c are increased to “7”. In this manner, one combination of symbols “7-7-7” is rearranged in a column direction, and the player can obtain a payout in the case where the combination “7-7-7” is rearranged on the basic line BL.

Next, a process executed in the slot machine 10 according to the first embodiment will be described in detail with reference to the accompanying drawings. The main CPU 41 reads out and executes a game program, thereby conducting the game.

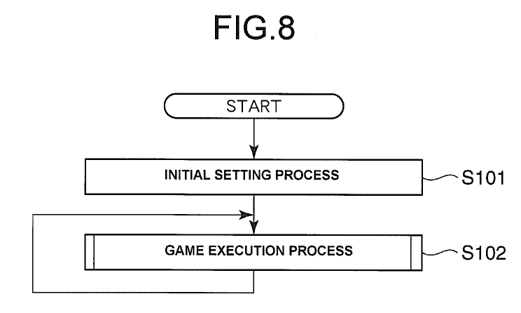

FIG. 8 is a flowchart showing a subroutine of a main process. In the main process, when a power switch is turned on (that is, when power is supplied) first, a mother board 40 and a gaming board 50 are activated respectively, and then, the CPU 51 executes an initial setting process (step S101). In the initial setting process, the main CPU 41 executes a BIOS stored in the ROM 42 to decompress the compressed data incorporated in the BIOS to the RAM 43, and executes the BIOS decompressed in the RAM 43, and performs diagnosis and initialization of each of the peripheral devices. Further, the main CPU 41 writes game programs or the like from the ROM 42 into the RAM 43, and acquires payout-ratio setting data and country-identification information. The main CPU 41 also performs an authentication process for each program during execution of the initial setting process.

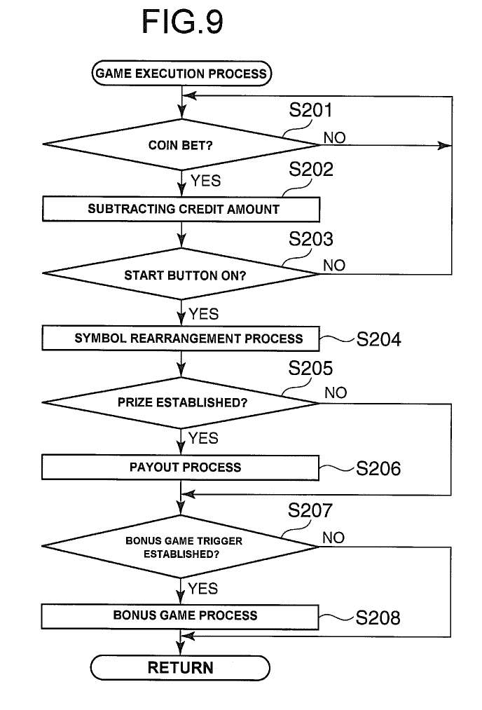

Next, the main CPU 41 performs a game execution process described later with reference to FIG. 9 (step S102). In the game execution process, the main CPU 41 sequentially reads and executes game programs or the like from the ROM 42. By performing the game execution process, the slot machine 10 executes the game according to the first embodiment. The game execution process is repeatedly performed while power is supplied to the slot machine 10.

FIG. 9 is a flowchart showing a subroutine of the game execution process invoked and performed at step S102 of the subroutine shown in FIG. 8. First, the main CPU 41 judges whether or not a coin has been bet (step S201). Specifically, the main CPU 41 judges whether an input signal output from the 1-BET switch 26S at the time of operation of the 1-BET button 26 has been received or whether an input signal output from the max BET switch 27S at the time of operation of the max BET switch 27 has been received. The main CPU 41 controls the current step to return to the process at the step S201 upon judging that no coin has been bet (step S201: NO).

On the other hand, the main CPU 41 subtracts the number of bet coins from the credit amount stored in the RAM 43 upon judging that a coin has been bet (step S201:YES). Where the number of bet coins is larger than the credit amount stored in the RAM 43, the main CPU 41 controls the current step to return to step S201 without performing the process for subtracting (step S202) the number of bet coins from the credit number stored in the RAM 43. Where the number of bet coins exceeds the upper limit (50 coins in this embodiment) of coins that can be bet in one game, the main CPU 41 controls the step to return to step 203 without performing the process for subtracting the number of bet coins from the credit number stored in the RAM 43.

At step S203, the main CPU 41 judges whether or not the start button 23 has been set to ON (step S203). Specifically, the main CPU 41 judges whether or not an input signal output from the start switch 23S at the time of pushing of the start button 23 has been received. The main CPU 41 controls the step to return to step 202 upon judging that the start button 23 has not been set to ON (step S203: NO). Where the start button 23 has not been set to ON (for example, where an instruction has been input to terminate the game without setting the start button 23 to ON), the main CPU 41 cancels acceptance of a subtraction result at step S202.

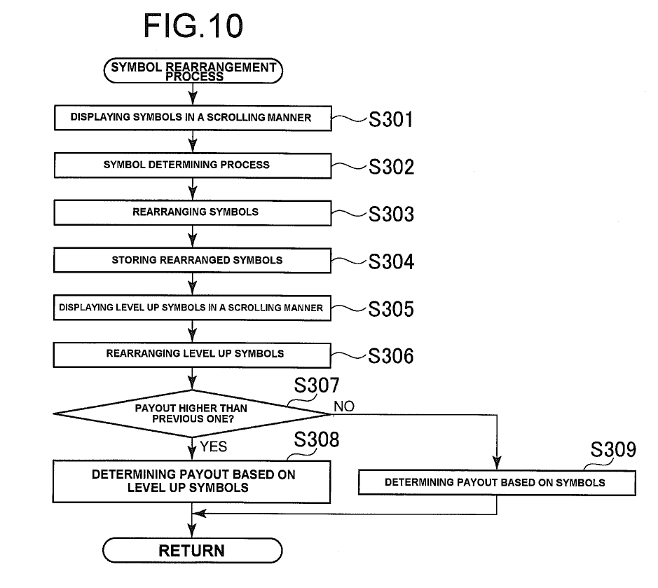

On the other hand, when the main CPU 41 judges that the start button 23 has been set to ON (step S203: YES), the main CPU 41 carries out symbol rearrangement process which will be described later with reference to FIG. 10 (step S204). Specifically, with respect to symbols and level up symbols rearranged on the lower image display panel 16, the CPU 41 executes a program stored in the RAM 43 to sample a random number value from a numerical value range of a predetermined random number value range. On the basis of the sampled random number value and symbol weighing data, the CPU 41 determines and rearranges the symbols “Blank”, “1Bar”, “2Bar”, “3Bar”, “7”, and “WILD”, and the level up symbols “+1”, “+2”, “+3”, and“+4”.

Next, the main CPU 41 judges whether a prize is established or not (step S205). Specifically, the main CPU 41 judges whether or not a combination of symbols rearranged in the symbol display area 28 is a winning combination in which any payout is performed. Here, the establishment of a prize means that a winning combination of predetermined symbols is established on a winning line (refer to FIG. 6).

Upon judging that the prize is established (step S205: YES), the main CPU 41 then performs a coin-payout process in accordance with the bet amount and the number of coins set for the winning combination (step S206). Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66.

On the other hand, upon judging that the prize is not established (step S205: NO), or when the main CPU 41 executes the process of step S206, the main CPU 41 judges whether or not a bonus game trigger is established (step S207). Specifically, the main CPU 41 executes a program stored in the RAM 43 to sample a random number value from a numerical value range of a predetermined random number value range. On the basis of the sampled random number value, the main CPU 41 judges whether or not the bonus game trigger is established. When the main CPU 41 judges that the bonus game trigger is established (step S207: YES), the main CPU 41 carries out a bonus game execution process (step S208). In the bonus game execution process, the main CPU 41 sequentially reads and executes game programs or the like from the ROM 42 to carry out the bonus game execution process.

On the other hand, when the main CPU 41 judges that the bonus game trigger is not established (step S207: NO) or when the main CPU 41 executes the process in step S208, the main CPU 41 terminates the game execution process.

FIG. 10 is a flowchart showing a subroutine of the symbol rearrangement process invoked and executed in step S204 of the subroutine shown in FIG. 9. First, the main CPU 41 displays symbols in the symbol display area 28 in a scrolling manner (step S301). Specifically, the main CPU 41 starts rotation of the reels 101a to 101i. At this time, six basic lines BL are set along the column direction or the row direction in the symbol display area 28, and two cross lines CL obliquely across the symbol display area 28 are set.

Next, the main CPU 41 carries out a symbol determining process (step S302). Specifically, with respect to the symbols rearranged in the symbol display area 28, the CPU 41 executes a program stored in the RAM 43 to sample a random number value from a numerical value range of a predetermined random number value range. On the basis of the sampled random number value and symbol weighting data, from among the symbols “Blank”, “1Bar”, “2Bar”, “3Bar”, “7”, and “WILD”, and the level up symbols “+1”, “+2”, “+3”, and “+4”, the CPU 41 determines those to be rearranged in the symbol display area 28.

Next, the main CPU 41 carries out rearrangement of symbols (step S303). Specifically, the main CPU 41 stops rotation of the reels 101a to 101i so as to display, in a stopped manner, the symbols determined at step S302, thereby rearranging the symbols.

Next, the main CPU 41 stores the rearranged symbols (step S304). Specifically, the main CPU 41 stores in the RAM 43 the symbols rearranged in the symbol display area 28 at step S303.

First, the main CPU 41 displays level up symbols in the symbol display area 28 in a scrolling manner (step S305). Specifically, the main CPU 41 starts rotation of the level up reels 102a to 102c.

Next, the main CPU 41 carries out rearrangement of level up symbols (step S306). Specifically, the main CPU 41 stops rotation of the level up reels 103a to 103c so as to display, in a stopped manner, the level up symbols determined at step S302, thereby rearranging the level up symbols (refer to FIG. 7A).

Next, the main CPU 41 judges whether or not a payout of symbols is higher than that of previously arranged ones (step S307). Specifically, the main CPU 41 judges whether or not a payout of the symbols stored in step S304 is higher than that of level up symbols after rearranged. When the main CPU 41 judges that the payout of the symbols is higher than that of the previously arranged ones (step S307: YES), the main CPU 41 determines a payout based on the level up symbols (step S308). For example, in case that the level up symbol 110d of “+2” is rearranged after superposed on a symbol “1Bar”, a level of “2Bar” is increased to “7”, and in this manner a payout in a case where the level up symbol is rearranged is determined (refer to FIG. 7B). The main CPU 41 terminates the symbol rearrangement process when executing the process in step S308.

On the other hand, when the main CPU 41 judges that the payout of the symbols is not higher than that of the previous ones (step S307: NO), the main CPU 41 determines a payout based on the symbols (step S309). For example, in case that a combination of the symbols stored in step S304 is a winning combination and the combination of the symbols is no longer a winning combination due to the level up symbols rearranged at step S306, a payout is determined based on the winning combination of the symbols stored in step S304. The main CPU 41 terminates the symbol rearrangement process when executing the process in step S309.

Next, a slot machine 10 according to a second embodiment will be described with reference to the accompanying drawings. The slot machine according to the second embodiment below has an appearance, a circuit configuration, and the like that are substantially the same as those of the slot machine 10 according to the first embodiment of the present invention. Thus, a duplicated explanation is omitted here. In addition, the constituent elements corresponding to those of the slot machine 10 are designated by the same reference numerals and are explained.

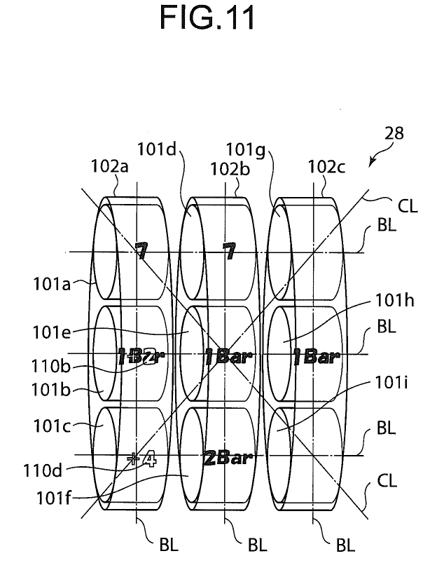

FIG. 11 is a view showing one example of rearranged symbols according to the second embodiment. As shown in FIG. 11, for the reels 101a and 101d, symbols “7” are displayed in a stopped state; for the reels 101b, 101e, and 101h, symbols “1Bar” are displayed in a stopped state; for the reel 101f, “2Bar” is displayed in a stopped state; and for other reels, symbols “Blank” are displayed in a stopped state. In this case, for these reels, a combination of symbols “1Bar-1Bar-1 Bar” are displayed in a stopped state on the basic line BL, so that the player can obtain a payout by a winning combination of symbols “1Bar-1Bar-1Bar”. However, when, on the level up reel 102a, the level up symbol 110d of “+2” is displayed on a stopped state, after superposed on the reel 101b, a payout of a combination of symbols “1Bar-1Bar-1Bar” increases by “+2”, and is changed to that which is to be performed in the case where a combination of symbols “3Bar-3Bar-3Bar” is displayed on a stopped state on the basic line BL.

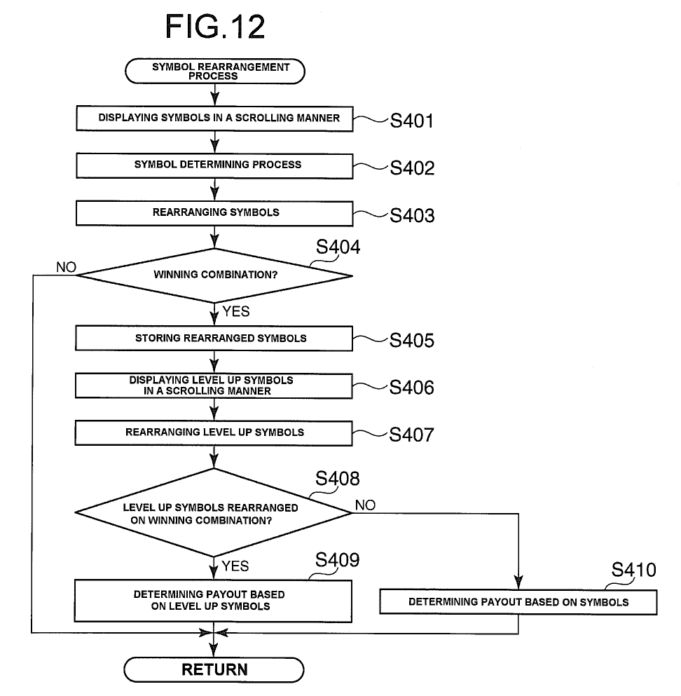

FIG. 12 is a flowchart showing a subroutine of the symbol rearrangement process invoked and executed at step S204 of the subroutine shown in FIG. 9 according to the second embodiment. First, the main CPU 41 displays symbols in the symbol display area 28 in a scrolling manner (step S401). Specifically, the main CPU 41 starts rotation of the reels 101a to 101i. At this time, six of the basic lines BL are set along the column direction or the row direction in the symbol display area 28, and two cross lines CL obliquely across the symbol display area 28 are set.

Next, the main CPU 41 carries out a symbol determination process (step S402). Specifically, with respect to symbols rearranged in the symbol display area 28, the CPU 41 executes a program stored in the RAM 43, thereby sampling a random number value from a numerical value range of a predetermined random number value range. On the basis of the sampled random number value and symbol weighting data, from among the symbols “Blank”, “1Bar”, “2Bar”, “3Bar”, “7”, and “WILD”, and the level up symbols “+1”, “+2”, “+3”, and “+4”, the CPU 41 determines those to be rearranged in the symbol display area 28

Next, the main CPU 41 carries out rearrangement of symbols (step S403). Specifically, the main CPU 41 stops rotation of the reels 101a to 101i so as to displayed, in a stopped state, the symbols determined at step S402, thereby rearranging the symbols.

Next, the main CPU 41 judges whether a winning combination is established or not (step S404). Specifically, the main CPU 41 judges whether or not the symbols rearranged on the basic lines BL and the cross lines CL serving as winning lines in the symbol display area 28 at step S403, are in any winning combination of the symbols “WILD-WILD-WILD”, “7-7-7”, “3Bar-3Bar-3Bar”, “2Bar-2Bar-2Bar”, and “1Bar-1Bar-1Bar”. In case that the main CPU 41 judges that the symbols are not in a winning combination (step S404: NO), the main CPU 41 terminates the symbol rearrangement process when the process of step S405 is executed.

On the other hand, when the main CPU 41 judges that the symbols are in a winning combination (step S404: YES), the main CPU 41 stores the rearranged symbols (step S405). Specifically, the main CPU 41 stores the symbols rearranged in the symbol display area 28 at step S403 in the RAM 43.

Next, the main CPU 41 displays level up symbols in the symbol display area 28 in a scrolling manner (step S406). Specifically, the main CPU 41 starts rotation of the level up reels 102a to 102c.

Next, the main CPU 41 carries out rearrangement of level up symbols (step S407). Specifically, the main CPU 41 stops rotation of the level up reels 103a to 1103c so as to displayed, in a stopped state, the level up symbols determined at step S402, thereby rearranging level up symbols (see FIG. 11).

Next, the main CPU 41 judges whether or not the level up symbols are rearranged on a winning combination (step S408). Specifically, the main CPU 41 judges whether or not any of the level up symbols 110 made up of “+1”, “+2”, “+3”, and “+4” is rearranged on a winning combination. When the main CPU 41 judges that a level up symbol is rearranged on a winning combination (step S408: YES), the main CPU 41 determines a payout based on the level up symbol (step S409). For example, when the level up symbol 110 is rearranged in a winning combination of symbols “1Bar-1Bar-1Bar” after superposed on any of the reels 101 existing on the winning combination, a payout of “1Bar-1Bar-1 Bar” increases by “+2”, and a payout to be performed in the case where a winning combination of symbols “3Bar-3Bar-3Bar” is rearranged on the basic line BL, is set (refer to FIG. 11). The main CPU 41 terminates the symbol rearrangement process when executing the process in step S409.

On the other hand, when the main CPU 41 judges that a level up symbol is not rearranged on a winning combination (step S408: NO), the main CPU 41 determines a payout based on the symbols (step S410). For example, in case that the level up symbol 110 is not rearranged after superposed on a winning combination of symbols “1Bar-1Bar-1Bar” by the level up reel 102, a payout is determined based on a winning combination of the symbols stored in step S405. The main CPU 41 terminates the symbol rearrangement process when executing the process in step S410.

Next, a slot machine 10 according to a third embodiment will be described with reference to the accompanying drawings. The slot machine according to the third embodiment below has an appearance, a circuit configuration, and the like that are substantially the same as those of the slot machine 10 according to the first embodiment of the present invention. Thus, a duplicated explanation is omitted hereinafter. In addition, the constituent elements corresponding to those of the slot machine 10 are designated by the same reference numerals and are explained.

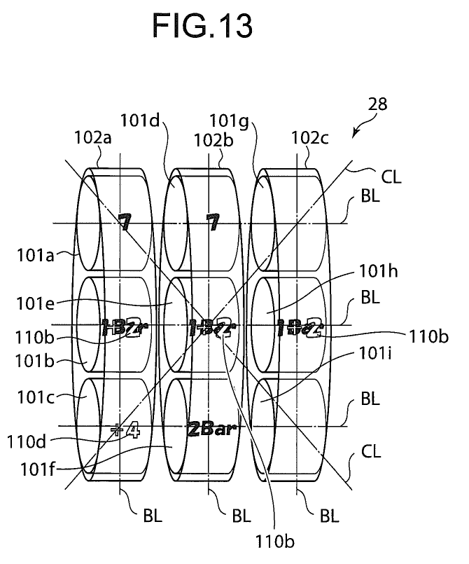

FIG. 13 is a view showing one example of rearranged symbols according to the third embodiment. As shown in FIG. 13, for the reels 101a and 101d, symbols “7” are displayed in a stopped state; for the reels 101b, 101e, and 101h, symbols “1Bar” are displayed in a stopped state; for the reel 101f, symbol “2Bar” is displayed in a stopped state; and on other reels, symbols “Blank” are displayed in a stopped state. In this case, a combination of symbols “1Bar-1Bar-1Bar” is displayed in a stopped state on the basic line BL in the row direction, so that the player can receive a payout by a winning combination of symbols “1Bar-1Bar-1Barr”. However, when, on the level up reels 102a to 102c, the level up symbols 110b of “+2” are displayed in a stopped state after superposed on the reels 101b, 101e, and 101h, a payout of symbols “1Bar-1Bar-1Bar” is increased for “+2”, and is changed to that made in the case where symbols “3Bar-3Bar-3Bar” are displayed in a stopped state on the basic line BL in the row direction.

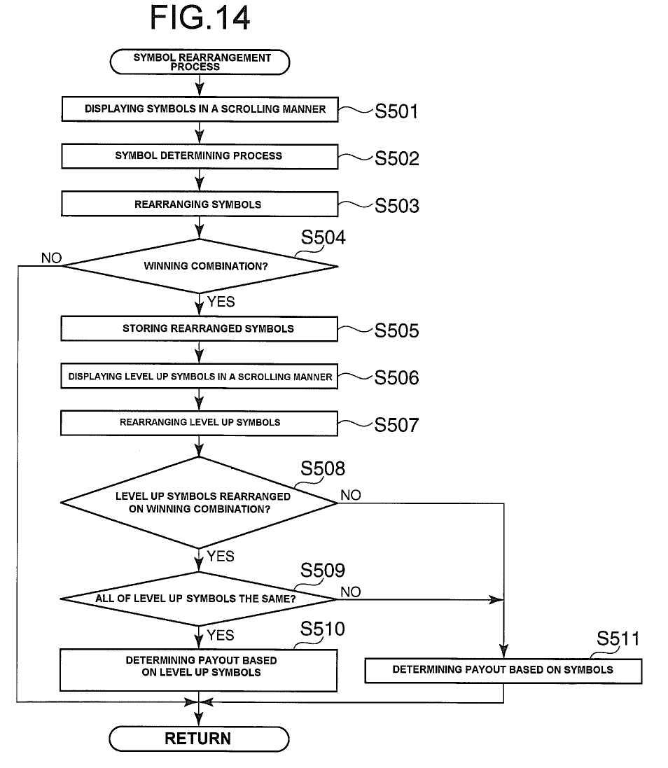

FIG. 14 is a flowchart showing a subroutine of the symbol rearrangement process invoked and executed at step S204 of the subroutine shown in FIG. 9 according to the second embodiment. First, the main CPU 41 displays symbols in the symbol display area 28 in a scrolling manner (step S501). Specifically, the main CPU 41 starts rotation of the reels 101a to 101i. At this time, six basic lines BL are set along the column direction or the row direction in the symbol display area 28, and two cross lines CL obliquely across the symbol display area 28 are set.

Next, the main CPU 41 carries out symbol determination process (step S502). Specifically, with respect to symbols rearranged in the symbol display area 28, the CPU 41 executes a program stored in the RAM 43 to sample a random number value from a numerical value range of a predetermined random number value range. On the basis of the sampled random number value and symbol weighing data, from among the symbols “Blank”, “1Bar”, “2Bar”, “3Bar”, “7”, and “WILD”, and the level up symbols “+1”, “+2”, “+3”, and “+4”, the CPU 41 determines those to be rearranged in the symbol display area 28.

Next, the main CPU 41 carries out rearrangement of symbols (step S503). Specifically, the main CPU 41 stops rotation of the reels 101a to 101i so as to display, in a stopped state, the symbols determined at step S502, thereby rearranging the symbols.

Next, the main CPU 41 judges whether or not a winning combination is established (step S404). Specifically, the main CPU 41 judges whether or not the symbols rearranged on the basic lines BL and the cross lines CL serving as winning lines in the symbol display area 28 at step S503 are in any winning combination of symbols “WILD-WILD-WILD”, “7-7-7”, “3Bar-3Bar-3Bar”, “2Bar-2Bar-2Bar”, and “1Bar-1Bar-1Bar”, depending on a combination of the symbols. In case that the main CPU 41 judges that the symbols are not in a winning combination (step S504: NO), the main CPU 41 terminates the symbol rearrangement process when the process of step S504 is executed.

On the other hand, when the main CPU 41 judges that the symbols are in a winning combination (step S504: YES), the main CPU 41 stores the rearranged symbols (step S505). Specifically, the main CPU 41 stores in the RAM 43 the symbols rearranged in the symbol display area 28 at step S503.

Next, the main CPU 41 displays level up symbols in the symbol display area 28 in a scrolling manner (step S506). Specifically, the main CPU 41 starts rotation of the level up reels 102a to 102c.

Next, the main CPU 41 carries out rearrangement of level up symbols (step S507). Specifically, the main CPU 41 stops rotation of the level up reels 103a to 103c so as to display, in a stopped state, the level up symbols determined at step S502, thereby rearranging the level up symbols (refer to FIG. 13).

Next, the main CPU 41 judges whether or not the level up symbols are rearranged on a winning combination (step S508). Specifically, the main CPU 41 judges whether or not any of the level up symbols 110 made up of “+1”, “+2”, “+3”, and “+4” is rearranged on a winning combination. When the main CPU 41 judges that level up symbols are rearranged on a winning combination (step S508: YES), the main CPU 41 judges whether or not all of the level up symbols are the same (step S509). For example, the main CPU 41 judges whether or not the level up symbols 110 of “+2-+2-+2” are rearranged on a winning combination of symbols “1Bar-1Bar-1Bar” by the level up reels 102. When the main CPU 41 judges that the level up symbols are all the same, the main CPU 41 determines a payout based on the level up symbols (step S510). For example, in case that the level up symbols “+2-+2-+2” are rearranged after superposed on symbols “1Bar-1Bar-1Bar”, the player obtains a payout in the case where a combination of symbols “3Bar-3Bar-3Bar” are displayed in a stopped state on the basic line BL in the row direction. The main CPU 41 terminates the symbol rearrangement process when executing the process in step S510.

On the other hand, when the main CPU 41 judges that level up symbols are not rearranged on a winning combination (step S508: NO), or that the level up symbols are not all the same (step S509: NO), the main CPU 41 determines a payout based on symbols (step S511). For example, in case that all of the level up symbols 110 are not rearranged after superposed on a winning combination of symbols “1Bar-1Bar-1Bar” by the level up reels 102, and in case that the same level up symbols 110 are not rearranged on a superposed manner on a winning combination of symbols “1Bar-1Bar-1Bar”, a payout is determined based on a winning combination of the symbols stored at step S505. The main CPU 41 terminates the symbol rearrangement process when executing the process at step S511.

In the foregoing, while the embodiments of the present invention have been described, these embodiments merely present specific examples. An appropriate design change can be made for the specific configuration of each means or the like. Also, the effects described in the embodiments of the present invention are only listing the most preferable effects arising from the present invention, and the effects of the present invention are not limited to those described in the embodiments of the present invention.

What is claimed is:

1. A slot machine, comprising:
a symbol matrix display area in which a plurality of symbols are arranged in a column direction and in a row direction;
a plurality of first reels that are provided corresponding to individual areas of the symbol matrix display area, and that have a plurality of kinds of first symbols different in payouts arranged thereon;
second reels that are provided on an outer peripheral side of the plurality of first reels so as to enclose first reels provided in the column direction among the plurality of first reels; and
a processor that controls drive of the first reels and the second reels, wherein:
the second reels have second symbols arranged thereon, the second symbols being rearranged after superposed on the first symbols of the first reels when the first symbols are rearranged in the symbol matrix display area, the second symbols changing a payout of the first symbols of the first reels to a higher payout or a lower payout, and
the processor is programmed to:
(a) control rotation of the plurality of the first reels to rearrange the first symbols arranged on the first reels in the symbol matrix display area;
(b) control rotation of the second reels to rearrange the second symbols arranged on the second reels in the symbol matrix display area so as to superpose the second symbols arranged on the second reels on the first symbols of the first reels rearranged in the symbol matrix display area; and
(c) award a prize after changing a payout with respect to a winning combination by the first symbols based on the second symbols of the second reels rearranged after superposed on the first symbols, in case that rearrangement of the first symbols of the first reels rearranged in the symbol matrix display area is a winning combination on an activated line in the column direction, the row direction, or a diagonal direction.

2. The slot machine according to claim 1, wherein
the second reels are provided corresponding to one of the plurality of first reels arranged in the row direction.

3. The slot machine according to claim 1, wherein
the processor awards a prize after changing a payout with respect to a winning combination by the first symbols based on the second symbols of the second reels rearranged superposed on the first symbols, in case that the same second symbols of the second reels are rearranged after superposed on all of the first symbols of the first reels constituting the winning combination in the process (c).

4. A slot machine, comprising:
a symbol matrix display area in which a plurality of symbols are arranged in a column direction and in a row direction;
a plurality of first reels that are provided corresponding to individual areas of the symbol matrix display area, and that have a plurality of kinds of first symbols different in payouts arranged thereon;
second reels that are provided on an outer peripheral side of the plurality of first reels so as to enclose first reels provided in the column direction among the plurality of first reels; and
a processor that controls drive of the first reels and the second reels, wherein
the second reels are provided corresponding to one of the plurality of first reels arranged in the row direction, and have second symbols arranged thereon, the second symbols being rearranged after superposed on the first symbols of the first reels when the first symbols are arranged in the symbol matrix display area, the second symbols changing a payout of the first symbols of the first reels to a higher payout or a lower payout, and
the processor is programmed to:
(a) control rotation of the plurality of first reels to rearrange the first symbols arranged on the first reels in the symbol matrix display area;
(b) control rotation of the second reels to rearrange the second symbols arranged on the second reels in the symbol matrix display area so as to superpose the second symbols arranged on the second reels on the first symbols of the first reels rearranged in the symbol matrix display area; and
(c) award a prize after changing a payout with respect to a winning combination by the first symbols based on the second symbols of the second reels rearranged after superposed on the first symbols, in case that rearrangement of the first symbols of the first reels rearranged in the symbol matrix display area is a winning combination on an activated line in the column direction, the row direction, or a diagonal direction.

5. The slot machine according to claim 4, wherein
the processor awards a prize after changing a payout with respect to a winning combination by the first symbols based on the second symbols of the second reels rearranged after superposed on the first symbols, in case that the same second symbols of the second reels are rearranged after superposed on all of the first symbols of the first reels constituting the winning combination in the process (c).

6. A slot machine, comprising:
a symbol matrix display area in which a plurality of symbols are arranged in a column direction and in a row direction;
a plurality of first reels that are provided corresponding to individual areas of the symbol matrix display area, and that have a plurality of kinds of first symbols different in payouts arranged thereon;
second reels that are provided on an outer peripheral side of the plurality of first reels so as to enclose the first reels provided in the column direction among the plurality of first reels; and
a processor that controls drive of the first reels and the second reels, wherein
the second reels have second symbols arranged thereon, the second symbols being rearranged after superposed on first symbols of the first reels when the first symbols are arranged in the symbol matrix display area, the second symbols changing a payout of the first symbols of the first reels to a higher payout or a lower payout, and
the processor is programmed to:
(a) control rotation of the plurality of first reels to rearrange the first symbols arranged on the first reels in the symbol matrix display area;
(b) control rotation of the second reels to rearrange the second symbols arranged on the second reels in the symbol matrix display area so as to superpose the second symbols arranged on the second reels on the first symbols of the first reels rearranged in the symbol matrix display area; and
(c) award a prize after changing a payout with respect to a winning combination by the first symbols based on the second symbols of the second reels rearranged after superposed on the first symbols, in case that rearrangement of the first symbols of the first reels rearranged in the symbol matrix display area is a winning combination on an activated line in the column direction, the row direction, or a diagonal direction, and the same second symbols of the second reels are rearranged after superposed on all of the first symbols of the first reels that constitute the winning combination.
